(19) United States
(12) Patent Application Publication
(10) Pub. No.: US 2024/0198711 A1
(43) Pub. Date: Jun. 20, 2024

(54) BOOK BINDING ASSEMBLY

(71) Applicant: KEVIN P. PARKER, Berkeley, CA (US)

(72) Inventor: KEVIN P. PARKER, Berkeley, CA (US)

(21) Appl. No.: 18/590,272

(22) Filed: Feb. 28, 2024

Related U.S. Application Data
(62) Division of application No. 18/122,663, filed on Mar. 16, 2023, now Pat. No. 11,958,310.
(62) Division of application No. 17/522,194, filed on Nov. 9, 2021, now abandoned.

(51) Int. Cl. B42C 11/04; B42C 7/00

(52) U.S. Cl. CPC B42C 11/04; B42C 7/00; B42C 7/004; B42C 7/005; B42C 7/006

(57) ABSTRACT

A book binding assembly in the form of a stack of hardcovers for making hardcover books, with the hardcovers having pressure sensitive adhesives on both sides for securing a cover wrap onto the hardcovers. Liner sheets are disposed over the upper hardcover and intermediate the hardcovers of the stack to protect the various adhesive elements. In addition, the liner sheets possess attributes which enable an end user to accurately apply a cover wrap to the hardcover on which the liner sheet is disposed.

### BACKGROUND OF THE INVENTION

### 1. Field of the Invention

The present invention is generally related to the field of book binding and in particular to providing hardcover assemblies for books suitable for easy mounting of cover wraps.

### 2. Description of Related Art

Binding books utilizing desktop binding machines has become popular. Such books are frequently made using soft bound books incorporated into hardcovers which results in a very realistic simulated hardcover book. A final step in finishing hardcover bound books involves covering the book with a cover wrap which is frequently custom printed. It is important that the cover wrap be properly and accurately installed since minor misalignments can significantly detract from the appearance of the final product. U.S. Pat. No. 7,452,172 entitled METHOD OF MAKING AND APPLYING A HARDCOVER OVER-WRAP AND GUIDE APPARATUS (hereinafter the '172 patent) discloses one approach for applying hardcover over-wraps (sometimes referred to herein as “cover wrap”) to a hardcover. The contents of the '172 patent are fully incorporated herein by reference.

As can be seen in the '172 patent (see FIGS. 18-27) a guide 60 is used to assist in accurately securing a cover wrap 80 to a hardcover book. Although this approach has been found to be successful, a user does not always have access to binding apparatus such as guide 60. As will become apparent to those skilled in the art upon a reading of the following Detailed Description of the Invention together with the drawings, the present invention enables an accurate application of a cover wrap so as to produce an attractive book without the need for special tools such as guide 60.

### SUMMARY OF THE INVENTION

A book binding assembly made up of a stack of identical hardcovers, with each of the hardcovers having an outer wrap layer of pressure sensitive adhesive on one side and an inner wrap layer of pressure sensitive adhesive on the other side is disclosed. Each of the outer wrap adhesives is covered by an identical liner sheet, with each liner sheet also covering the inner wrap adhesive disposed above the liner. Thus, the outer and inner wrap adhesives are protected by the liner sheets.

In addition, the liner sheets possess attributes which enable the sheets to be used to provides accurate placement of an cover wrap onto the underlying hardcover. Such attributes can include, for example, the position of the liner sheet over the underlying hardcover. As a further example, attributes can include the dimensions of the liner sheet.

### BRIEF DESCRIPTION OF THE DRAWINGS

FIG. 1 is a top view one embodiment of a bookbinding assembly in a stack showing a liner sheet on top.

FIG. 2 is side view of the FIG. 1 assembly.

FIG. 3 is a top view of the FIG. 1 assembly showing liner sheet folded so as to expose a portion of the underlying adhesive on the hardcover.

FIG. 4 is a side view of the FIG. 3 assembly.

FIG. 5 is a top view of the FIG. 1 assembly showing a cover wrap over the liner sheet, with the under lying liner sheet still folded.

FIG. 6 is a side view of the FIG. 5 assembly.

FIG. 7 is a top view of the FIG. 1 assembly showing the cover wrap partially attached to the hardcover, with the liner sheet serving as an alignment guide.

FIG. 8 is a side view of the FIG. 7 assembly.

FIG. 9 is a top view of the FIG. 1 assembly showing final removal of the liner sheet while maintaining proper alignment of the cover wrap with the hardcover.

FIG. 10 is a side view of the FIG. 9 assembly.

FIG. 11 is a top view of the FIG. 1 assembly showing the cover wrap secured to the upper surfaces of the hardcover

FIG. 12 is a side view of the FIG. 10 assembly.

FIG. 13 is a top view of the FIG. 1 assembly with the covered hardcover being lifted from the stack.

FIG. 14 is a side view of the FIG. 13 assembly.

FIG. 15 shows the FIG. 13 assembly flipped over revealing the unattached edges of the outer wrap.

FIG. 16 is a side view of the FIG. 15 assembly.

FIG. 17 is a partial view of an edge of a hardcover with a portion of a liner sheet extending past the edge.

FIG. 18 is a top view of the FIG. 15 hardcover showing the covering process completed.

FIG. 19 is a side view of the FIG. 18 hardcover.

FIG. 20 is a top view of another embodiment of a bookbinding assembly in a stack showing a liner sheet over a hardcover.

FIG. 21 is another top view of the FIG. 20 assembly with a fold formed in the liner sheet to assist in aligning an outer wrap over the hardcover.

FIG. 22 is further top view of the FIG. 20 assembly with another fold in the liner sheet to expose a portion of the hardcover adhesive.

FIG. 23 is a still further top view of the FIG. 20 assembly showing a cover wrap disposed in the fold to assist in aligning the cover wrap over the hardcover.

FIG. 24 is a top view of a further embodiment of a bookbinding assembly in a stack showing a liner sheet over a hardcover.

FIG. 25 is a top view of the FIG. 24 assembly showing the liner sheet pulled partially back to expose a segment of adhesive on the hardcover.

FIG. 26 is a top view of the FIG. 24 assembly showing a cover wrap secured to the exposed adhesive segment of FIG. 25 thereby fixing the cover wrap alignment on the hardcover.

### DETAILED DESCRIPTION OF THE INVENTION

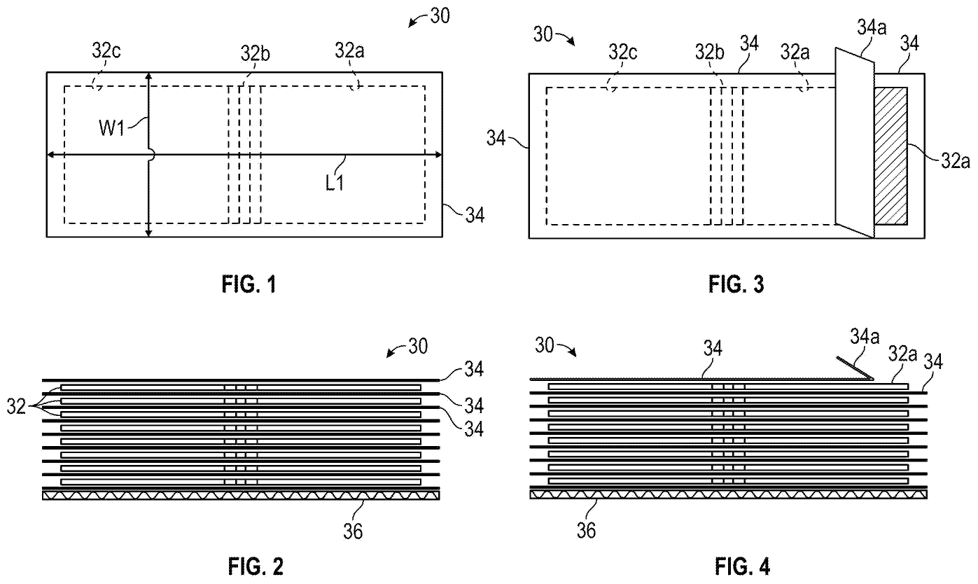

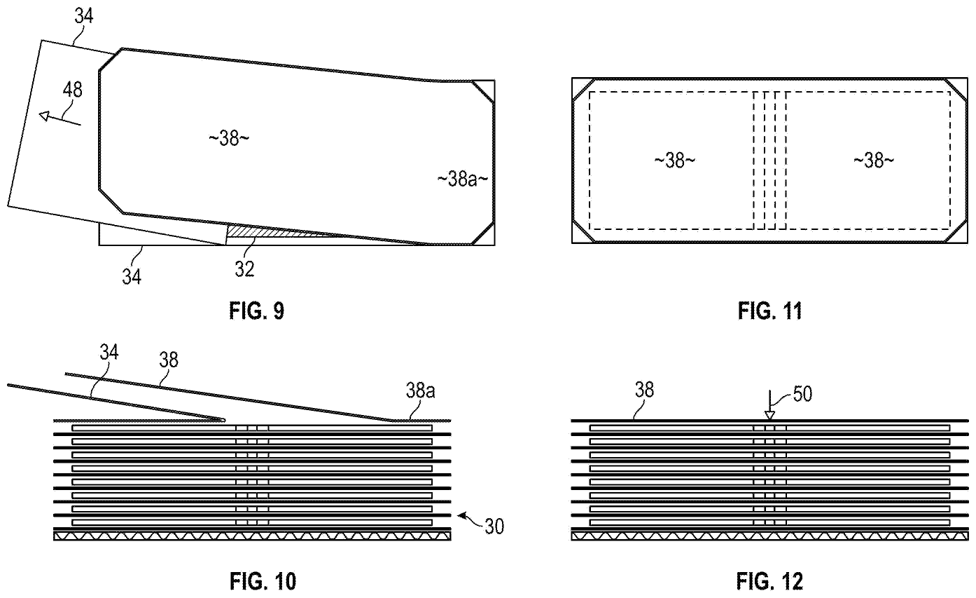

Referring to the drawings, FIGS. 1 and 2 depict a stack 30 of eight cover assemblies, with each cover assembly including a hardcover 32 and associated liner sheet 34. Each hardcover includes front and rear cover pieces 32a and 32b and an intermediate spine piece 32c. A hinging element (not depicted), secures the three pieces 32a, 32b, and 32c to form a hardcover. The outer surface of the hardcover are covered with a thin layer of pressure activated adhesive (not designated) referred to as the outer wrap adhesive. This adhesive functions to secure a cover wrap 38 (see FIG. 9, e.g.) to the outer side of the hardcover. Typically, the cover wrap 38 includes a title and other graphics which are preprinted. The inner surface of the hardcover 32 includes a band 46 (FIG. 15) of heat activated inner wrap adhesive which extends around the periphery of the hardcover. This adhesive is sometimes referred to as the inner wrap adhesive and functions to secure the wrapped edges of the cover wrap to the inner surfaces of the hardcover. It is anticipated that stack 30 would be mass produced and sold to an end user who would complete the book making process including the addition of a cover wrap as will be described.

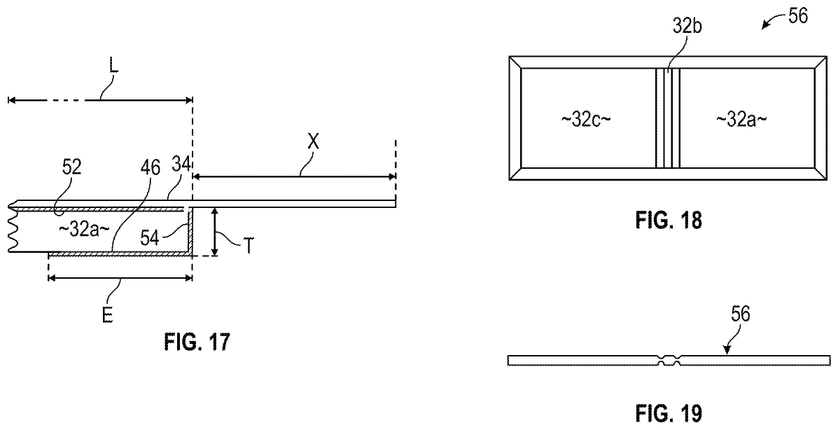

As will be seen, once an end user has applied the cover wrap to the outer surface of the hardcover 32, the edges of the cover wrap are folded around the edges of the cover sheet and held in place by the four bands 46 of inner wrap adhesive. Preferably, the edges of the hardcover are also covered with pressure sensitive adhesive which functions to further secure the cover wrap folded around those edges (FIG. 17).

A special liner sheet 34 is disposed over the cover adhesive of each the hardcovers in the stack in order to, among other things, protect the cover adhesive from any unintended adhering. As is common with all liner sheets, a coating on the sheets prevents the sheets from strongly adhering to the pressure sensitive adhesive. However, there is some adhesion so that a selected position of the liner sheet on the underlying hardcover is maintained. A further liner sheet, substantially identical to the other liner sheets in stack 30, is disposed below the upper hardcover, contacting the inner wrap adhesive 40 of the upper hardcover. Thus, the inner wrap adhesive is further protected from any unintended adhering. In addition, the further liner sheet is disposed over the cover adhesive of the second hardcover 32 disposed immediately below the further liner thus protecting that adhesive also. This arrangement continues for the remainder of the stack 30, with the last liner being disposed intermediate the last hardcover and then the bottom 36 of a shipping container. Since the various layers of pressure sensitive adhesive are somewhat tacky notwithstanding the presence of the liner sheets, the entire stack 30 will form a single integral unit which makes it convenient for shipping and handling by the end user.

In addition to the functions described above of the liner sheets 34, such sheets provide an important additional function. The liner sheets are configured to assist the end user to achieve accurate placement of a cover wrap on a hardcover without the aid of alignment tools such as guide 60 disclosed in the '172 patent. In one embodiment as shown in FIGS. 1-12, the liner sheets are dimensioned to track those dimensions of a wrap sheet designed to fit the hardcover on which the liner sheet is disposed. The wrap sheet is sized to extend over the outer cover of the hardcover and then around the edges of the hardcover and then over the pressure sensitive inner wrap adhesive 40 (FIGS. 15 and 17) bands disposed on the inner surface of the hardcover 32.

Some details regarding the manner in which a cover wrap, and hence a liner sheet 34 in this embodiment, wraps around one edge of a front cover 32 of a hardcover are depicted in FIG. 17. In this case the total length L of the hardcover is measured normal to the spine and the total width W is measured in a direction parallel to the spine An appropriate cover wrap should have a length L plus twice the distance X needed to wrap the cover around the opposite edges of the hard cover. Distance X is equal to the sum of the thickness T of the hardcover (ignoring the thickness of the thin layers of adhesive) and distance E, the width of the inner wrap adhesive band 40 extending over the interior surface of the hardcover, such as front cover 32a. Thus, the length L1 of liner sheet 34 (FIG. 1) should be L+2X or L+2T+2E taking into account two edges. Similarly, the width W1 of the liner sheet (FIG. 1) should be W+2T+2E. Note that during the manufacturing process, the liner sheets 32 are positioned on the hardcovers so that the liner sheets extend past the edges of the hardcovers by distance X on all four sides. The slight tackiness of the pressure adhesive will hold these two elements in place. In this embodiment, the liner sheet 34 is positioned on the hardcover at the final desired location of cover wrap, as will be described.

The process for accurately attaching a cover wrap to a hardcover will now be described. Referring to FIGS. 3 and 4, at this point the top most hardcover remains on the stack thereby providing a stable working platform. The end user separates a portion of the liner sheet 34a from the underlying outer wrap adhesive on the front cover 32a of the hardcover. The lifted section 34a of the liner sheet is folded down as shown in FIG. 4 against the remainder of the liner sheet thereby exposing a portion of adhesive covered hardcover 32a.

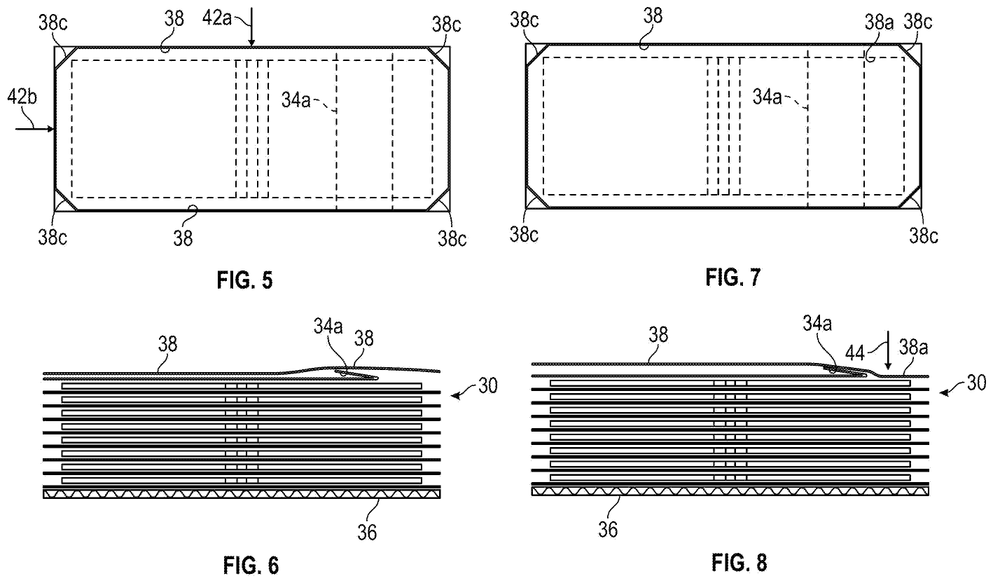

Next, as shown in FIGS. 5 and 6, a properly sized cover wrap 38 is positioned over the liner sheet, including folded section 34a. Care should be taken not to allow the cover wrap to contact the exposed adhesive during this alignment. Note also that the alignment preferably takes place at an end of the cover wrap opposite the exposed adhesive, such as the edges designated by arrows 42a and 42b. Once the respective edges of the cover wrap and the liner sheet are carefully aligned with one another, the desired relative position of the cover wrap and liner sheet (and thus the hardcover) is achieved.

With the wrap and liner sheet held in place by one hand, the second hand is free to press down in the area of the cover wrap indicated by arrow 44 of FIG. 8. At this point, the correct relative position of the cover wrap and the hardcover is secured by the exposed adhesive disposed on the front cover 32a of the hardcover. The user then removes the remaining portion of the liner sheet 34 by pulling on the sheet in the area indicated by arrow 48 of FIG. 9. Next, the user presses the liner sheet against the newly exposed adhesive on the hardcover, taking special care in the spine area as indicated by arrow 50 of FIG. 12. Note that this point, the hardcover is still positioned on the stack thereby maintaining a stable work surface. Care is taken to ensure that all regions of the cover wrap are smoothly pressed against the hardcover. A small hand tool can be use to assist in this smoothing process.

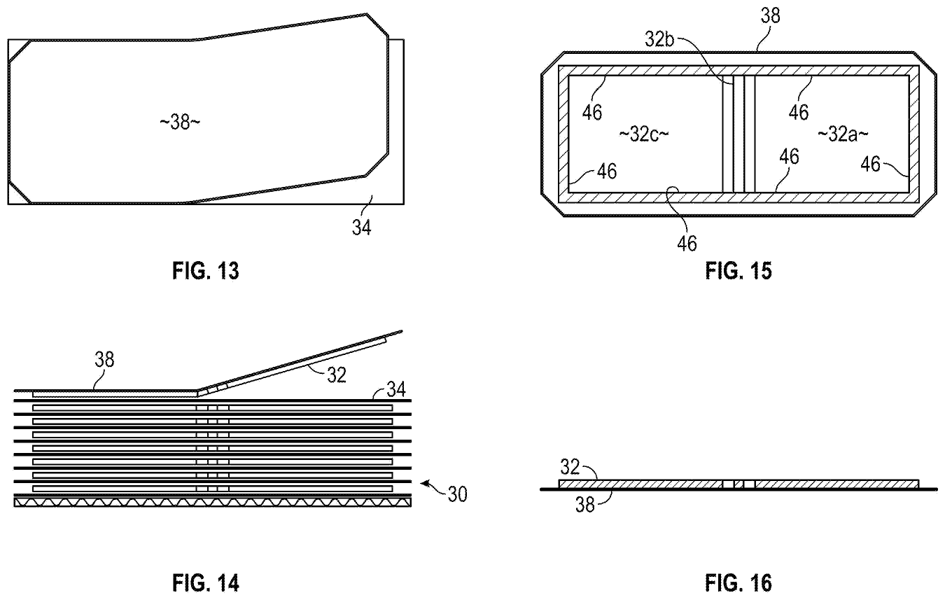

At this point the hardcover/cover wrap arrangement is lifted away from stack 30, as shown in FIGS. 13 and 14, with the underlying liner sheet 34 minimizing the force required. The arrangement is then flipped over and placed on a flat surface as shown in FIGS. 15 and 16. The four edges of the cover wrap are then manually folded around the respective edges of the hardcover and secured in place by the various sections of the inner wrap adhesive 40. This final process is well known in the art. One approach is to press one edge of the hardcover, along with the section of the adjacent cover wrap, against a flat surface and then rotate the hardcover so as to partially fold the cover wrap around the hardcover edge. Note that the four chamfers 38C (FIG. 5) located in the corners of the cover wrap facilitate this folding and provide the desired finished look. The user then manually finishes the wrap around process until the edge of the cover wrap is covering the associated inner wrap adhesive 40 segment. These steps are repeated for the remaining three hardcover edges thereby completing the accurate securing of the cover wrap 38 to the hardcover 32 as shown in FIGS. 18 and 19 which show the final hardcover 56. As before, no special tools, other than possibly a small hand held smoothing tool, are required to complete the process.

It can be seen that the above-described combination of hardcovers and liner sheets results in a binding product that allows for the production of an attractive hardcover book without the use of special tools, with the possible exception of the actual binding itself. Even in that case, well known techniques allow the binding to be carried out with only basic tools. The disclosed liner sheets provide not only the function of protecting the various pressure sensitive adhesives on the hardcovers from unintended adhesion, but also the function of guiding an end user in accurate placement of a cover wrap over the hardcover. To this end, the liner is configured to include certain attributes to assist in achieving this end. In the above-described embodiment, these attributes include certain dimensions of the hardcover such as the length L and width W. Those dimensions may also include values T and E as also described above. In addition, it can be seen that the position of the liner sheet over the hardcover during manufacture is an attribute of the liner sheet which also contributes to the proper alignment of the cover wrap and the hardcover.

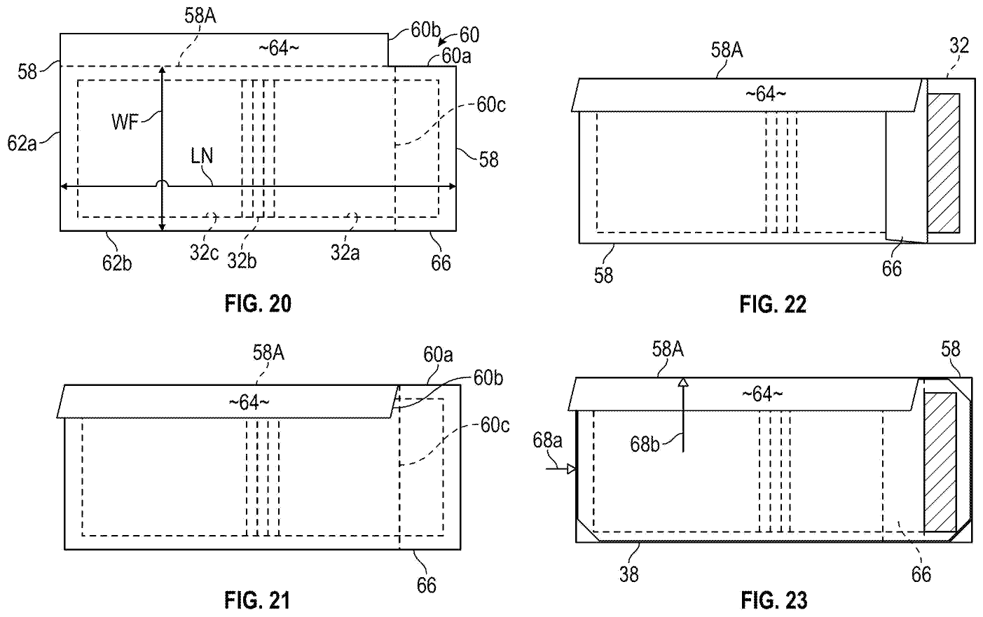

A further embodiment hardcover 32 and associated liner sheet 58 is shown in stack form in FIGS. 20 and 21. Liner sheet 58 has a generally rectangular form, with a notch 60 located in one corner. The liner sheet includes a fold line 58A which is spaced a distance WF from an opposite edge of the sheet. The liner sheet can be actually folded along line 58A during manufacture or perforations can be provided to assist in folding along the line by the end user. Distance WF is the same value as previously described distance W1, namely W+2T+2E where W is again the width of the hardcover and T and E are, respectively, the thickness of the hardcover and the width of the inner wrap adhesive band 40 as shown in FIG. 17. The length LN of liner sheet 58 is not critical provided the liner sheet extends past the edge of the underlying hardcover so as to cover the cover adhesive and so as to provide an region so that a user can grip the end of the sheet. Note that line 60C represents an ideal location to fold an end of the liner sheet to form a flap 66. The location of line 60C is not critical, but is ideally slightly offset from notch edge 60b so as to facilitate various folding steps. Note that fold line 58A is preferably aligned with edge 60a of notch 60. Liner 58 is positioned over the hardcover, and held in place there by the slightly tacky adhesion between the liner sheet and the pressure sensitive adhesive, during manufacture so that the distance between edge 62a of the liner sheet and the edge of the hardcover is value X or E+T (FIG. 17). The distance between edge 62b of the liner sheet and the edge of the hardcover is also set during manufacture to value X.

In order to apply a cover wrap 38, the end user leaves the top liner sheet 58 and underlying hardcover on the top of the stack so that, once again, the stack will provide a stable work surface. In the event that the liner sheet was not folded during manufacture, the end user carefully folds the liner, preferably using perforations located along line 58A, to produce a flap member 64 as shown in FIG. 21. Next, the end of liner sheet is folded near line 60C to reveal a section of adhesive located on the outer surface of the hardcover The resultant flap 66 is tucked under flap 64 as shown in FIG. 22. Note that the slight displacement between notch edge 64b and line 60c (FIG. 20) keeps flaps 64 and 66 from interfering from one another during this operation.

The cover wrap 38 is then positioned on the liner sheet as depicted in FIG. 23 taking care to not allow the sheet to contact the small portion of the exposed hardcover adhesive. The liner sheet is positioned over the folded flap 66 at this point. A long edge of the cover wrap 38 is then positioned under flap 64 until the edge is disposed along the entire length of fold line 58A as represented by arrow 68b. Since the edge of the liner sheet is somewhat wedged in place between flap 64 and the under lying liner sheet, the liner sheet tends to stay in place while permitting lateral movement of the sheet. An edge of the liner sheet is then moved laterally until it is aligned with an edge of the hardcover as indicated by arrow 68a of FIG. 23. With both locations 68a and 68b aligned, a correct positioning of the cover wrap 38 over the liner sheet, and hence over the hardcover, is achieved. The user then maintains this position by pressing down on flap 64 with one hand. The user then, using the other hand, forces that portion of the cover wrap extending over the exposed adhesive down against the adhesive thereby securing the cover wrap and the hardcover together with the correct alignment. The user then removes the last of the liner sheet so that the reminding hardcover adhesive 32 is exposed. The user then proceeds to complete the process of securing the cover wrap as previously described in connection with the first embodiment.

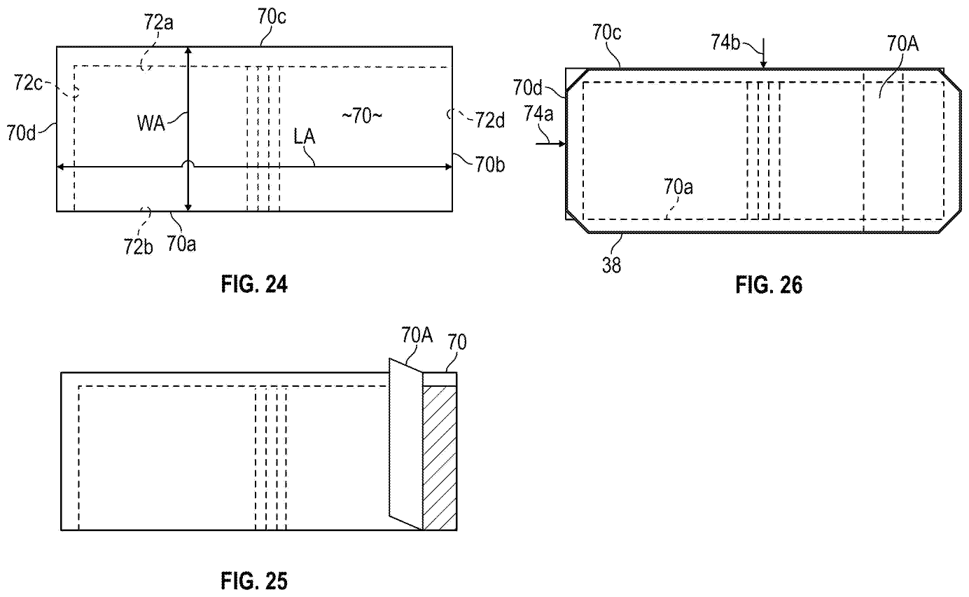

FIGS. 24-26 show a further embodiment of a hardcover/liner sheet arrangement. In this case, the arrangement is manufactured such that liner sheet 70 is positioned on the hardcover 32 such that edge 70b of the liner sheet is aligned with edge 72d of the hardcover. Similarly, edge 70a of the liner sheet is aligned with 72b of the hardcover. In order for the liner sheet to provide the desired guide function with this position, the liner sheet edge 70c should extend a distance past the hardcover edge 72a of T+E, where values T and E were previously explained in connection with FIG. 17. Also, the liner sheet edge 70d should extend past the edge 72c a distance of T+E. Thus, the width WA of liner sheet 70 is substantially equal to W+T+E and the length LA is substantially equal to L+T+E. (As previously noted, values W and L represent the width and length, respectively, of the hardcover.)

As shown in FIG. 25, the user then exposes a region of the outer wrap adhesive on the hardcover by lifting a section 70A of the liner away from the hardcover. The lifted section forms a flap 70A that is folded flat against the remainder of the liner. Next, the cover wrap 38 is positioned over the liner sheet 70 with orthogonal edges of the liner 70b and 70a being aligned with the corresponding orthogonal edges of the cover wrap (not designated). These alignment points are designated by arrows 74a and 74b. Note also that the cover wrap edge extends past the corresponding edge 70a of the liner sheet for this embodiment. When achieving this alignment, care must be taken not to contact the exposed adhesive. Once the alignment has been made, the cover wrap is held in place to maintain the alignment while liner sheet is completely removed thereby exposing the remainder of the adhesive. The cover wrap is then presses against the adhesive over the full surface of the hardcover as previously described. The edges are then finished as also previously described thereby completing the process.

As described above, various embodiments of bookbinding assemblies have been disclosed which enable an end user to accurately apply an outer wrap to a hardcover without the need for specialized tools such as alignment guides. Although these embodiments have been described in some detail, it is to be understood that various changes can be made by those skilled in the art after reading the above Detailed Description of the Invention together with the drawings without departing from the spirit and scope of the invention as defined by the appended claims.

1. A book binding assembly comprising:
a plurality of substantially identical liner sheets;
a plurality of substantially identical hardcovers, with each of the hard covers having first and second outer orthogonal edges and comprising a front cover piece, a back cover piece and a spine piece;
a pressure sensitive front adhesive layer covering substantially all of an outer surface on a front side of the front and rear cover pieces and the spine piece of the hardcovers;
a pressure sensitive rear adhesive extending along a periphery of an inner surface on a backside of at least the front and rear back cover pieces of the hardcovers extending a distance E from edges of the hardcovers;
a first one of the liner sheets covering the front adhesive layer of a first one of the hardcovers; and
a second one of the liner sheets covering the rear adhesive of the first one of the hardcovers and covering the front adhesive layer of a second one of the hardcovers;
with the liner sheets possessing fold lines displaced from first edges of the liner sheets and orthogonal with respect to second edges of the liner sheets, with the liner sheets positioned on the hardcovers such that the fold lines are displaced away from the hardcovers a distance X1 from the first edges of the hardcovers, with the distance X1 being at least as great as distance E; and
whereby the liner sheets can be used as a guide in positioning cover wraps on the hardcovers including aligning an edge of the cover wraps with the fold lines of the liner sheets associated with the hardcovers.

2-22. (canceled)

23. The book binding assembly of claim 1 wherein the liner sheets are folded along the fold lines.

24. The book binding assembly of claim 23 wherein the fold lines divide the liner sheets into flap members disposed intermediate the fold lines and the first edges of the liner sheets and into central portions, with liner sheets being folded such that the flap members are positioned facing the respective central portions.

25. The book binding assembly of claim 24 wherein the liner sheets have second edges orthogonal to the fold lines, with the second edges of the liner sheets being displaced from the second edges of the hardcovers the distance X1.

26. The book binding assembly of claim 25 wherein the liner sheets have third edges opposite the first edges of the liner sheets and fourth edges opposite the second edges of the liner sheets, with the fold lines being shorter than the third edges so that the flap members are displaced from the fourth edges of the liner sheets.

27. The book binding assembly of claim 23 wherein the plurality of liner sheets are folded in a common direction such that the flap members of the second liner sheet are disposed intermediate the central portion of the second liner sheet and the first hardcover.

28. The book binding assembly of claim 27 wherein the second edges of the liner sheets are displaced the distance X1 from the respective second edges of the hardcovers.

29. The book binding assembly of claim 28 wherein the hardcovers have a thickness of distance T and wherein distance X1 is the sum of the distances E and T.

30. The book binding assembly of claim 1 wherein the fold lines of the liner sheets are defined by perforations in the liner sheets.

31. The book binding assembly of claim 30 wherein the second edges of the liner sheets are displaced from the second edges of the hardcovers the distance X1.

32. The book binding assembly of claim 31 wherein the fold lines divide the liner sheets into flap members disposed intermediate the fold lines and the first edges of the liner sheets, and central portions, with the liner sheets having third edges opposite the first edges of the liner sheets and fourth edges opposite the second edges of the liner sheets, with the fold lines being shorter than the third edges so that the flap members are displaced from the fourth edges of the liner sheets.

33. The book binding assembly of claim 32 wherein the second edges of the liner sheets are displaced the distance X1 from the respective second edges of the hardcovers.

34. The book binding assembly of claim 33 wherein the hardcovers have a thickness of distance T and wherein distance X1 is the sum of the distances E and T.

35. A book binding assembly comprising:
first, second and third substantially identical hardcovers, with each hardcover having first and second outer orthogonal edges and including a front side, with a front adhesive layer disposed on the front side, and a backside, with a rear adhesive disposed on the backside and extending a distance E from edges of the hardcover;
first, second and third substantially identical liner sheets, with each liner sheet including first and second edges, means for defining fold lines, with the fold lines displaced from the first edges of the liner sheet and orthogonal with respect to the second edges of the liner sheets, with regions of the liner sheet intermediate the fold lines and the first edges of the liner sheet forming flap members; and
with the first liner sheet being disposed over the first hardcover and contacting the front adhesive layer of the first hardcover, with the second liner sheet being disposed intermediate the first and second hardcovers and contacting the rear adhesive and front adhesive layers of the respective first and second hardcovers, with the third liner sheet being disposed intermediate the second and third hardcovers and contacting the rear adhesive and front adhesive layers of the respective second and third hardcovers, and
with the fold lines of the liner sheets being displaced a distance X1 from the first edges of the respective hardcovers, with the distance X1 being at least as great as distance E; and
whereby the flap members can be used to aid in accurately positioning cover wraps on the respective hardcovers.

36. The bookbinding assembly of claim 35 wherein the means for defining a fold line include perforations in the liner sheets.

37. The bookbinding assembly of claim 35 wherein the means for defining a fold line include a fold formed in the liner sheet along the fold line to define flap members in the respective liner sheets disposed intermediate the fold lines and the first edges of the liner sheets.

38. The book binding assembly of claim 37 wherein the first, second and third liner sheets are each folded in a common direction such that the flap member of the second liner sheet is positioned adjacent a central portion of the second liner sheet, with the flap member of the second liner sheet being disposed intermediate the central portion of the second liner sheet and the first hardcover.

39. The bookbinding assembly of claim 35 wherein the hardcovers have a thickness of distance T at the first and second edges of the hardcovers and wherein the distance X1 is the sum of distances E and T.

40. A book binding assembly comprising:
first, second and third substantially identical hardcovers, with each hardcover including a front side, with a front adhesive layer disposed on the front side, and a backside, with a rear adhesive disposed along a periphery of the backside, and first and second orthogonal outer edges, with the rear adhesive extending a distance E from the first and from the second edges of the hardcover and with the hardcovers having a thickness T at the first and second edges of the hardcover;
first, second and third substantially identical liner sheets, with each liner sheet including first and second edges, a fold along a fold line, with the fold line displaced from the first edges of the liner sheet and orthogonal with respect to the second edges of the liner sheets, with a region of the liner sheets disposed intermediate the fold line and the first edge of the liner sheet forming a flap member, with the fold line length being such that an end of the flap members is displaced from fourth edges of the liner sheets opposite the second edges of the liner sheets;
with the first liner sheet being disposed over the first hardcover and contacting the front adhesive layer of the first hardcover, with the second liner sheet being disposed intermediate the first and second hardcovers and contacting the rear adhesive and front adhesive layers of the respective first and second hardcovers and with the third liner sheet being disposed intermediate the second and third hardcovers and contacting the rear adhesive and front adhesive layers of the respective second and third hardcovers and with the fold lines of the liner sheets being displaced away from the hardcovers a distance X1 from the first edges of the respective hardcovers, with the distance X1 being equal to the sum of the distances T and E; and
with the first, second and third liner sheets each folded in a same direction such that the flap member of the second liner sheet is positioned adjacent a central portion of the second liner sheet, with the flap member of the second liner sheet disposed intermediate the central portion of the second liner sheet and the first hardcover;
whereby the folded flap members can be used to aid in accurately positioning cover wraps on the respective hardcovers.

41. The bookbinding assembly of claim 40 wherein the second edges of the liner sheets are displaced the distance X1 from the second edges of the respective hardcovers.
